(19) United States
(12) Patent Application Publication
(10) Pub. No.: US 2009/0080391 A1
(43) Pub. Date: Mar. 26, 2009

(54) Network interworking system and method for negotiating qos in network interworking system

(76) Inventors: Hye Yeon Kwon, Daejeon-city (KR); Hyung-Cheol Shin, Daejeon-city (KR); Kwang-Hyun Ro, Daejeon-city (KR); Jae-Wook Shin, Daejeon-city (KR); Kwang-Ryul Jung, Daejeon-city (KR); You-Sun Hwang, Seoul (KR); Kyung-Yul Cheon, Daejeon-city (KR); Ae-Soon Park, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 11/920,996

(22) PCT Filed: Nov. 4, 2005
(86) PCT No.: PCT/KR2005/003722

§ 371 Date: Nov. 26, 2007

(30) Foreign Application Priority Data
May 25, 2005 (KR) 10-2005-0044123

(51) Int. Cl. H04W 74/00

(52) U.S. Cl. 370/338

(57) ABSTRACT

A 3GPP-WLAN interworking system to which WLAN user equipment is accessed includes a WLAN access network including a WLAN access point, a 3GPP packet-switched service network including terminal equipment, a 3GPP core network connecting the WLAN access network and the 3GPP packet-switched service network, and a packet data gateway relaying the 3GPP core network and the 3GPP packet-switched service network. The WLAN user equipment negotiates a QoS according to a wireless environment with the WLAN access point to generate a WLAN bearer, negotiates a QoS according to a type of user data with the packet data gateway to generate a WLAN 3GPP IP access bearer, and negotiates a QoS according to data process performance of the terminal equipment with the terminal equipment to generate an end-to-end bearer.

### TECHNICAL FIELD

The present invention relates to a network interworking system and a QoS negotiation method therein, and more specifically, to a network interworking system for efficiently negotiating a QoS requirement and a method thereof.

### BACKGROUND ART

Since the digital cellular-based second generation mobile communication system was launched, a third generation mobile communication system International Mobile Telecommunication 2000 (IMT-2000) has been standardized by the International Telecommunication Union (ITU) so as to support high quality multimedia services with no area limit. The third generation mobile communication system may provide a world-wide single communication service range through global roaming, and in addition to the existing voice services, It may provide wireless multimedia services including images, moving pictures, visual telephones, and Internet access since it supports a high data rate of 2 Mbps to the maximum in a high bandwidth.

While the third generation mobile communication system was initially standardized to form a single international system standard, it has failed. The third-generation mobile communication system is divided into a Universal Mobile Telecommunications System (UMTS) of Europe and Japan, and a Code Division Multiple Access 2000 (CDMA-2000) of North America.

The CDMA-2000 is being standardized by a third generation partnership projects 2 (3GPP2). In addition, the CDMA-2000 uses a North-America standard IS-41-based network protocol as a core network, and uses a synchronization method as an air interface, the synchronous method for synchronizing base stations.

The UMTS is being standardized by a third generation partnership projects (3GPP). The UMTS uses Global System for Mobile communications (GSM)- Mobile Application Part (MAP) as the core network, and uses an asynchronous method as the air interface.

The 3GPP uses a Release concept in system standardization, and 3GPP-WLAN Wireless Local Area Network) interworking has been an important issue in Release 6. The 3GPP-WLAN interworking is performed to provide services and functions of the 3GPP to a user in the WLAN environment. The 3GPP-WLAN interworking is still being standardized, but a configuration of the QoS network for providing a QoS requirement in relation to the 3GPP-WLAN interworking has not been suggested.

The third generation mobile communication system provides a service in a packet-switched method, contrasting with a circuit-switched method. In the packet-switched method, a communication message is divided, and a data packet referred to as a packet including destination address and the divided communication message is transmitted. The third generation mobile communication system is an all-IP network in which respective nodes of the network are communicated with each other based on internet protocol (IP), and the communication message is interchanged through the IP in the third generation mobile communication system. Since the communication message is divided into a plurality of packets in the packet-switched method, a plurality of users may share the same channel in a network. When types of packet input to the respective nodes of the network are the same as each other, an equal priority or an equal policy may be applied to the input packet or a combination of the input packet in a corresponding node, which is referred to as a best effort method.

However, a QoS requirement for the respective packets may not be provided only by using the best effort method since bandwidth may not be expanded limitlessly in a network nowadays, and different packet types relating to the visual telephone, broadcasting, multimedia, and voice over internet protocol (VoIP) are used in the network. Specifically, since the third generation mobile communication service is to provide various services including voice, image, moving picture, visual telephone, and Internet access services, it is required to standardize the QoS requirement in the third generation mobile communication service. However, as described above, the QoS network configuration for providing the QoS requirement in relation to the 3GPP-WLAN interworking has not been suggested yet.

The above information disclosed in this Background section is only for enhancement of understanding of the background of the invention and therefore it may contain information that does not form the prior art that is already known in this country to a person of ordinary skill in the art

### DISCLOSURE

### Technical Problem

The present invention has been made in an effort to provide a network interworking system for efficiently negotiating a QoS and a QoS negotiation method in the network interworking system.

### Technical Solution

An exemplary network interworking system according to an embodiment of the present invention includes a wireless access network including wireless access equipment to which a user terminal is accessed, a packet-switched service network including terminal equipment providing a packet-switched service, a core network for connecting the wireless access network and the packet-switched service network, and a gateway relaying the core network and the packet-switched service network. In addition, the exemplary network interworking system includes a first bearer, a second bearer, a third bearer, and a fourth bearer. The first bearer is formed between the user terminal and the wireless access equipment according to a quality of service (QoS) provided according to a wireless environment. The second bearer is formed between the user terminal and the gateway according to a QOS provided according to a type of the user data. The third bearer is formed between the gateway and the terminal equipment according to a QoS provided by the packet-switched service network. The fourth bearer is formed between the user terminal and the terminal equipment according to a QoS provided according to data process performance.

An exemplary network interworking system according to another embodiment of the present invention includes a wireless access network to which a user terminal is accessed, a packet-switched service network providing a packet-switched service, and a core network connecting the wireless access network and the packet-switched service network. In addition, the exemplary network interworking system includes wireless access equipment, a gateway, and terminal equipment. The wireless access equipment is included in the wireless access network to negotiate a first QoS with the user terminal in relation to radio resources provided to the user terminal. The gateway relays the core network and the packet-switched service network. The terminal equipment is included in the packet-switched service network to negotiate a second QoS according to data process performance with the user terminal. The gateway negotiates a third QoS provided by the packet-switched service network with the terminal equipment, and negotiates a fourth QoS provided according to a type of user data with the user terminal.

An exemplary quality of service (QoS) negotiation method of a user terminal according to another embodiment of the present invention is to negotiate a QoS in a network interworking system including a wireless access network including wireless access equipment to which a user terminal is accessed, a packet-switched service network including terminal equipment providing a packet-switched service a core network connecting the wireless access network and the packet-switched service network, and a gateway relaying the core network and the packet-switched service network. In the QoS negotiation method, a first bearer negotiating a QoS provided according to a wireless environment with the wireless access equipment in the wireless access network is generated, a second bearer negotiating a QoS provided according to a type of user data with the gateway is generated, and a third bearer negotiating a QoS provided according to data process performance of the terminal equipment with the terminal equipment is generated. In addition, the gateway negotiates a QoS provided by the packet-switched service network with the terminal equipment.

An exemplary QoS negotiation method of a gateway relaying a core network and a packet-switched service network according to another embodiment of the present invention is to negotiate a QoS in a network interworking system including a wireless access network to which a user terminal is accessed, the packet-switched service network including terminal equipment providing a packet-switched service, and the core network connecting the wireless access network and the packet-switched service network. In the exemplary QoS negotiation method, a first bearer negotiating a QoS provided according to a type of user data with the user terminal is generated and a second bearer negotiating a QoS provided by the packet-switched service network with the terminal equipment is generated. In addition, the user terminal generates a third bearer negotiating a QoS provided according to a wireless environment with the wireless access equipment in the wireless access network and generates a fourth bearer negotiating a QoS provided according to data process performance of the terminal equipment with the terminal equipment.

An exemplary QoS negotiation method of a user terminal according to another embodiment of the present invention is to negotiate a QoS in a network interworking system including a wireless access network to which the user terminal is wirelessly accessed, the wireless access network connected to a first packet-switched service network providing a packet-switched service, a second packet-switched service network providing the packet-switched service, and a core network connecting the wireless access network and the second packet-switched service network. In the exemplary QoS negotiation method, an authentication is obtained from the core network, a first bearer negotiating a QoS according to a wireless environment with wireless access equipment in the wireless access network is generated and a second bearer negotiating a QoS according to data process performance with the terminal equipment in the packet-switched service network is generated. In addition, the wireless access equipment generates a third bearer negotiating a QoS negotiated by the first packet-switched service network with the terminal equipment.

### Advantageous Effects

According to the exemplary embodiment of the present invention, the WLAN user equipment may exchange the user data with the terminal equipment of the 3GPP packet-switched service network by efficiently negotiating the QoS in the 3GPP-WLAN interworking system.

In addition, according to the exemplary embodiment of the present invention, since the security of the WLAN access network which is a different type of network from the 3GPP packet-switched service network is guaranteed, the WLAN user equipment may exchange the user data with the terminal equipment while guaranteeing security of the data when the 3GPP-WLAN interworking system is wirelessly accessed to the WLAN access network.

### DESCRIPTION OF DRAWINGS

FIG. 1 shows a diagram representing a third generation partnership projects (3GPP)-wireless local area network (WLAN) interworking system according to an exemplary embodiment of the present invention.

FIG. 2 shows a diagram representing a quality of service (QoS) network configuration for a WLAN direct IP access according to the exemplary embodiment of the present invention.

FIG. 3 shows a flowchart representing a QoS negotiation and acceptance process between network constituent elements according to the QoS network configuration for the WLAN direct IP access according to the exemplary embodiment of the present invention.

FIG. 4 shows a diagram representing a QoS network configuration for a WLAN 3GPP IP access according to the exemplary embodiment of the present invention.

FIG. 5 shows a flowchart representing a QoS negotiation and acceptance process between the network constituent elements according to the QoS network configuration for the WLAN 3GPP IP access according to the exemplary embodiment of the present invention.

FIG. 6 shows a flowchart representing a QoS negotiation process between WLAN user equipment and the 3GPP-WLAN interworking system according to the exemplary embodiment of the present invention.

FIG. 7 shows a flowchart representing a QoS negotiation method of a packet data gateway according to the exemplary embodiment of the present invention.

FIG. 8 shows a flowchart representing a QoS negotiation method used when the WLAN user equipment according to the exemplary embodiment of the present invention performs a WLAN direct IP access.

### BEST MODE

An exemplary embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. In addition, the drawings and description are to be regarded as illustrative in nature and not restrictive, and like reference numerals designate like elements throughout the specification.

Throughout this specification and the claims which follow, unless explicitly described to the contrary, the word “comprise” or variations such as “comprises” or “comprising” will be understood to imply the inclusion of stated elements but not the exclusion of any other elements.

A third generation partnership projects (3GPP)-wireless local area network (WLAN)Interworking system according to an exemplary embodiment of the present invention will now be described.

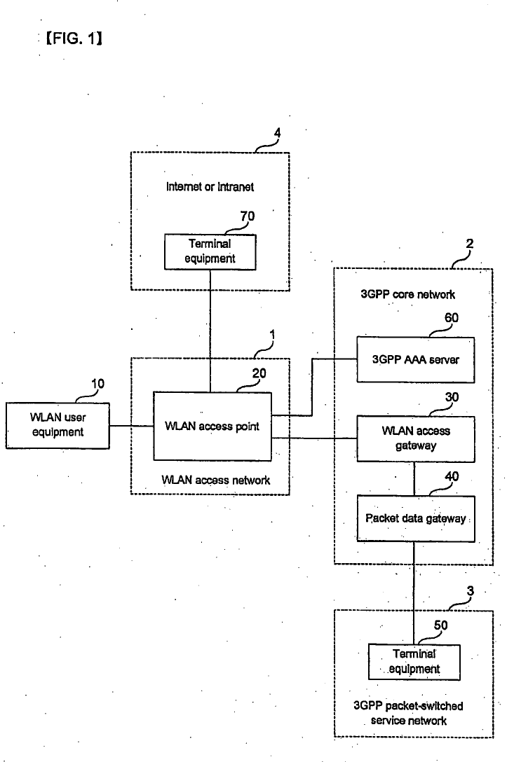

FIG. 1 shows a diagram representing the 3GPP-WLAN interworking system according to the exemplary embodiment of the present invention.

As shown in FIG. 1, the 3GPP-WLAN interworking system includes wireless local area network (WLAN) user equipment (UE) 10, a WLAN access network (AN) 1, a 3GPP core network (CN) 2, a 3GPP packet-switched service network 3, and an Internet or intranet 4.

The WLAN UE 10 accesses the WLAN AN 1 by using a user terminal subscribed to the 3GPP packet-switched service network 3. The WLAN UE 10 may only access the WLAN AN 1, or may access the WLAN AN 1 and a 3GPP access network. The 3GPP access network includes a node B providing a wideband code division multiple access(WCDMA) wireless access and a radio network controller (RNC) controlling the node B, and terminal equipment accessing the 3GPP access network is accessed to the 3GPP packet-switched service network 3 through the 3GPP access network. The WLAN UE 10 may be portable equipment, a laptop computer, a notebook computer, or a personal digital assistant (PDA) that respectively include a WLAN card, or it may be portable equipment, a laptop computer, a notebook computer, or a personal digital assistant (PDA) that respectively include the WLAN card and a 3GPP access module.

The WLAN AN 1 providing a WLAN access for the WLAN UE 10 includes at least one WLAN access point (AP) 20 performing the WLAN access to the WLAN UE 10. While the WLAN according to the IEEE 802.11 wireless access protocol is used in the exemplary embodiment of the present invention, the WLAN AN 1 may be a conventional wireless access network, and the WLAN access point may be wireless access equipment corresponding to the node B base station.

The 3GPP CN 2 connects the WLAN AN 1 and the 3GPP packet-switched service network 3, and it includes a WLAN access gateway (AG) 30, a packet data gateway (PDG) 40, and a 3GPP authentication authorization accounting server (3GPP AAA server) 60.

The WLAN AG 30 relays the WLAN AN 1 and the 3GPP CN 2. Since the WLAN AN 1 and the 3GPP CN 2 have different types of protocol, the WLAN AG 30 performs protocol translation to interchange information between the WLAN AN 1 and the 3GPP CN 2.

The PDG 40 relays the 3GPP CN 2 and the 3GPP packet-switched service network 3. Since the 3GPP CN 2 and the 3GPP packet-switched service network 3 have different types of protocol, the PDG 40 performs protocol translation to interchange information between the 3GPP CN 2 and the 3GPP packet-switched service network 3.

The 3GPP packet-switched service network 3 defined by the 3GPP provides a 3GPP packet-switched service to the WLAN UE 10. WLAN 3GPP IP access is to provide the 3GPP packet-switched service from the 3GPP packet-switched service network 3 to the WLAN UE 10 through the WLAN AN 1 and the 3GPP CN 2. A terminal network node, such as a server included in the 3GPP packet-switched service network 3 to provide the 3GPP packet-switched service to the WLAN UE 10, will be referred to as terminal equipment 50.

In addition, WLAN direct IP access is to access the WLAN UE 10 directly to the Internet or intranet 4 through the WLAN AN 1 so as to provide an IP-based service to the WLAN UE 10. The Internet or intranet 4 includes terminal equipment 70, and the terminal equipment 70 provides the IP-based service.

The 3GPP AAA server 60 performs user authentication, service authorization, and charging operations in the 3GPP-WLAN interworking system. The WLAN UE 10 receives an authentication from the 3GPP AAA server 60 so as to perform the WLAN 3GPP IP access or the WLAN direct IP access. In addition, the 3GPP AAA server 60 performs the charging operation according to the QoS, network usage, and bandwidth usage.

The Internet or intranet 4 is a type of packet-switched service network.

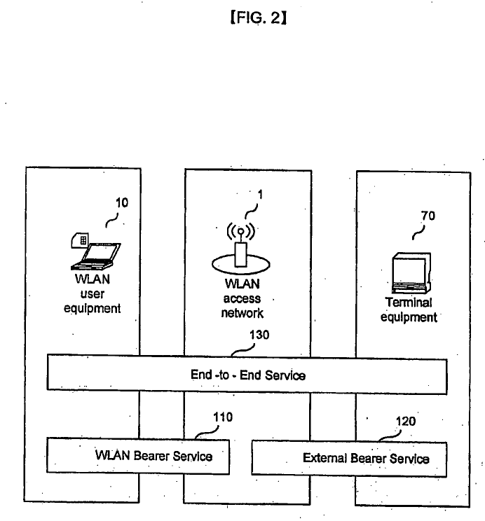

A QoS network configuration for the WLAN direct IP access according to the exemplary embodiment of the present invention will now be described with reference to FIG. 2.

FIG. 2 shows a diagram representing the QoS network configuration for the WLAN direct IP access according to the exemplary embodiment of the present invention.

As shown in FIG. 2, a network for the WLAN direct IP access according to the exemplary embodiment of the present invention includes the WLAN UE 10, the WLAN AP 20, and the terminal equipment 70, and the QoS network configuration for the WLAN direct IP access according to the exemplary embodiment of the present invention includes a WLAN bearer service 110, an external bearer service 120, and an end-to-end bearer service 130.

A bearer service is used to transmit/receive user data according to a contracted or negotiated QoS. The bearer service includes a control signaling function for QoS negotiation, a bearer generation function according to the QoS negotiation, a user data exchange function through the generated bearer, and a QoS management function. The bearer is an information transmitting path according to the negotiated QoS.

The WLAN UE 10 performs the QoS negotiation with the WLAN AP 20 in relation to radio resource allocation, and a radio channel which is a bearer for supporting the negotiated QoS is formed between the WLAN UE 10 and the WLAN AP 20 by performing the QoS negotiation. The WLAN bearer service 110 includes a radio channel formation and management function for forming and managing such a radio channel, and a user data transmitting function according to the negotiated QoS. That is, the user data are exchanged through the radio channel for supporting the negotiated QoS between the WLAN UE 10 and the WLAN AP 20.

A QoS to be provided by the Internet or intranet 4 is negotiated between the WLAN AP 20 and the terminal equipment 70, and a bearer for supporting the negotiated QoS is formed. Therefore, the external bearer service 120 includes a bearer formation and management function for forming and managing such a bearer, and the user data transmitting function according to the negotiated QoS.

Data process performance of the WLAN UE 10 is different from that of the terminal equipment 70. Specifically, the data process performance of the WLAN UE 10 is different from that of the terminal equipment 70 in a network layer according to an open systems interconnection (OSI) model and is a layer higher than the network layer (e.g., a transmission layer, a session layer, a presentation layer, and an application layer). For example, when a first terminal node transmits data to a second terminal node too fast to be processed, the second terminal node may lose the data. Therefore, the WLAN UE 10 and the terminal equipment 70 negotiate a QoS according to the data process performance, and a bearer for supporting the negotiated QoS is formed between the WLAN UE 10 and the terminal equipment 70. The end-to-end bearer service 130 includes the bearer formation and management function for forming and managing such a bearer, and the user data transmitting function according to the negotiated QoS.

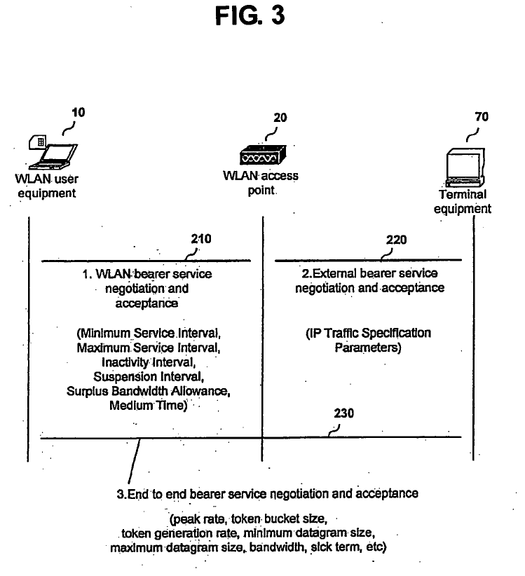

A QoS negotiation and acceptance process between network constituent elements according the QoS network configuration for the WLAN direct IP access according to the exemplary embodiment of the present invention will now be described with reference to FIG. 3.

FIG. 3 shows a flowchart representing the QoS negotiation and acceptance process between network constituent elements according to the QoS network configuration for the WLAN direct IP access according to the exemplary embodiment of the present invention.

A WLAN bearer service negotiation and acceptance process 210 is required to provide a WLAN bearer service 110 between the WLAN UE 10 and the WLAN AN 1. QoS parameters negotiated in the process 210 may include a minimum service interval, a maximum service interval, an inactivity interval, a suspension interval, a surplus bandwidth allowance, and a medium time. The QoS parameters negotiated for the WLAN bearer service 110 have been defined in the IEEE 802.11e.

An external bearer service negotiation and acceptance process 220 is required to provide the external bearer service 120 between the WLAN AN 1 and the terminal equipment 70. In the process 220, IP traffic specification parameters are negotiated.

An end-to-end bearer service negotiation and acceptance process 230 is required to provide the end-to-end bearer service 130 between the WLAN UE 10 and the terminal equipment 70. IP-based application service quality parameters negotiated in the process 230 may include a peak rate, a token bucket size, a token generation rate, a minimum datagram size, a maximum datagram size, a bandwidth, and a slack term.

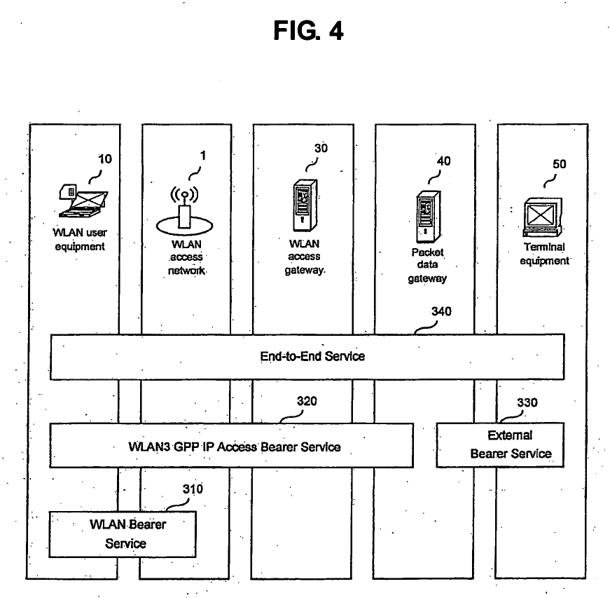

A QoS network configuration for the WLAN 3GPP IP access according to the exemplary embodiment of the present invention will now be described with reference to FIG. 4.

FIG. 4 shows a diagram representing the QoS network configuration for the WLAN 3GPP IP access according to the exemplary embodiment of the present invention.

As shown in FIG. 4, a network for the WLAN 3GPP IP access according to the exemplary embodiment of the present invention includes the WLAN UE 10, the WLAN AP 20, the WLAN AG 30, the PDG 40, the terminal equipment 50, and the QoS network configuration for the WLAN 3GPP IP access according to the exemplary embodiment of the present invention includes a WLAN bearer service 310, a WLAN 3GPP IP access bearer service 320, an external bearer service 330, and an end-to-end bearer service 340.

The WLAN UE 10 performs the QoS negotiation with the WLAN AP 20 in relation to radio resource allocation, and a radio channel which is a bearer for supporting the negotiated QoS is formed between the WLAN UE 10 and the WLAN AP 20 through the QoS negotiation. The WLAN bearer service 310 includes a bearer formation and management function for forming and managing such a bearer (hereinafter, referred to as a WLAN bearer), and a user data transmitting function according to the negotiated QoS. That is, the user data are exchanged through the radio channel for supporting the negotiated QoS between the WLAN UE 10 and the WLAN AP 20.

A QoS to be provided by the Internet or intranet 4 is negotiated between the PDG 40 and the terminal equipment 50, and a bearer for supporting the negotiated QoS is formed. Therefore, the external bearer service 330 includes a bearer formation and management function for forming and managing such a bearer (hereinafter, referred to as an external bearer), and the user data transmitting function according to the negotiated QoS.

The WLAN UE 10 performs the QoS negotiation for the WLAN 3GPP IP access with PDG 40, and receives different QoS requirements according to the user data. For example, when the user data relate to video on demand (VOD), the WLAN UE 10 performs the QoS negotiation to receive a QoS having a lesser maximum traffic delay and delay variation. In addition, when the user data relate to an Internet service, the WLAN UE 10 performs the QoS negotiation with the PDG 40 to receive a QoS having a relatively higher delay variation, and a low cost may therefore be charged. Therefore, the WLAN UE 10 negotiates a QoS for the WLAN 3GPP IP access with the PDG 40, and a bearer for supporting the negotiated QoS is formed between the WLAN UE 10 and the PDG 40. The WLAN 3GPP IP access bearer service 320 includes a bearer formation and management function for forming and managing such a bearer (hereinafter, referred to as a WLAN 3GPP IP access bearer), and the user data transmitting function according to the negotiated QoS. Specifically, the WLAN 3GPP IP access bearer service 320 may encrypt the user data. Since the WLAN UE 10 communicates with the terminal equipment of the 3GPP packet-switched service network 3, there may be a security problem in a user data path to the 3GPP packet-switched service network 3. Therefore, when the WLAN 3GPP IP access bearer service 320 additionally provides a user data encryption service, the above security problem in exchanging the user data between the WLAN UE 10 and the 3GPP packet-switched service network 3 may be solved.

Data process performance of the WLAN UE 10 is different from that of the terminal equipment 50. In further detail, the data process performance of the WLAN UE 10 is different from that of the terminal equipment 50 in a network layer according to the OSI model, and is a layer higher than the network layer (e.g., a transmission layer, a session layer, a presentation layer, and an application layer). For example, when a first terminal node transmits data to a second terminal node too fast to be processed, the second terminal node may loss the data. Therefore, the WLAN UE 10 and the terminal equipment 50 negotiate a QoS requirement according to the data process performance, and a bearer for supporting the negotiated QoS is formed between the WLAN UE 10 and the terminal equipment 50. The end-to-end bearer service 130 includes the bearer formation and management function for forming and managing such a bearer (hereinafter, referred to as an end-to-end bearer), and the user data transmitting function according to the negotiated QoS.

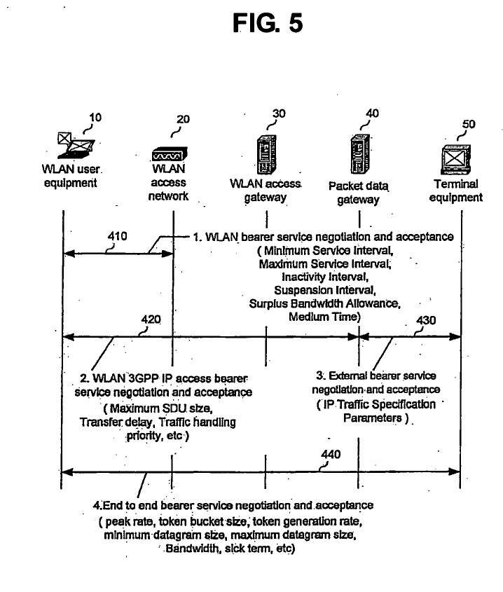

A QoS negotiation and acceptance process between network constituent elements according to the QoS network configuration for the WLAN 3GPP IP access according to the exemplary embodiment of the present invention will now be described with reference to FIG. 5.

FIG. 5 shows a flowchart representing the QoS negotiation and acceptance process between the network constituent elements according to the QoS network configuration for the WLAN 3GPP IP access according to the exemplary embodiment of the present invention.

A WLAN bearer service negotiation and acceptance process 410 is required to provide the WLAN bearer service 310 between the WLAN UE 10 and the WLAN AP 20. QoS parameters negotiated in the process 410 may include the minimum service interval, the maximum service interval, the inactivity interval, the suspension interval, the surplus bandwidth allowance, and the medium time.

A WLAN 3GPP IP access bearer service negotiation and acceptance process 420 is required to provide the WLAN 3GPP IP access bearer service 320 between the WLAN UE 10 and the PDG 40. In this process 420, a maximum service data unit (SDU) size (octets), a transfer delay, and a traffic handling priority may be negotiated.

Maximum SDU size (octets) is a maximum size of an available service data unit when user data are transmitted. The SDU indicates a data unit exchanged through a logical communication path between peer layers when respective nodes for performing data communication are classified as layers.

The transfer delay, is a maximum allowance delay when the SDU is transmitted.

The traffic handling priority is a priority value for processing traffic, and is a value used to perform admission control and scheduling operations.

An external bearer service negotiation and acceptance process 430 is required to provide the external bearer service 330 between the PDG 40 and the terminal equipment 50. In the process 430, IP traffic specification parameters are negotiated.

An end-to-end bearer service negotiation and acceptance process 440 is required to provide the end-to-end bearer service 340 between the WLAN UE 10 and the terminal equipment 50. IP-based application service quality parameters negotiated in the process 440 may include the peak rate, the token bucket size, the token generation rate, the minimum datagram size, the maximum datagram size, the bandwidth, and the slack term.

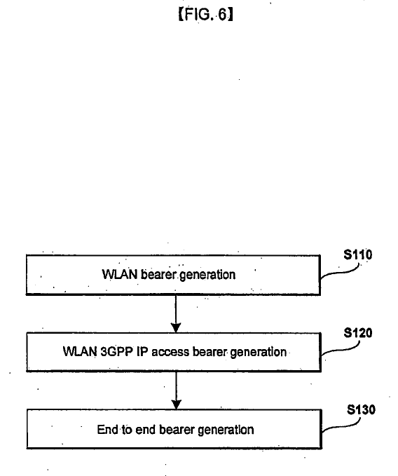

FIG. 6 shows a flowchart representing a QoS negotiation process between the WLAN UE 10 and the 3GPP-WLAN interworking system according to the exemplary embodiment of the present invention.

Firstly, the WLAN UE 10 negotiates a QoS provided according to a wireless environment with the WLAN AP 20, and generates a WLAN bearer in step S110.

In addition, the WLAN UE 10 negotiates a QoS provided according to a type of the user data with the PDG 40, and generates a WLAN 3GPP IP access bearer in step S120. At this time, the PDG 40 negotiates a QoS provided by the 3GPP packet-switched service network 3 with the terminal equipment 50, and generates an external bearer.

The WLAN UE 10 negotiates a QoS requirement provided according to the data process performance of the terminal equipment 50 with the terminal equipment 50, and generates an end-to-end bearer in step S130.

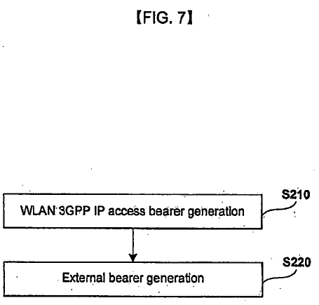

FIG. 7 shows a flowchart representing a QoS negotiation method of the PDG 40 according to the exemplary embodiment of the present invention.

Firstly, the PDG 40 negotiates a QoS provided according to a type of the user data with the WLAN UE 10, and generates a WLAN 3GPP IP access bearer in step S210. At this time, the WLAN UE 10 negotiates a QoS provided according to the wireless environment with the WLAN AP 20, and generates a WLAN bearer. In addition, the WLAN UE 10 negotiates a QoS provided according to the data process performance of the terminal equipment 50 with the terminal equipment 50, and generates an end-to-end bearer.

The PDG 40 negotiates a QoS provides by the 3GPP packet-switched service network 3 with the terminal equipment 50, and generates an external bearer in step S220.

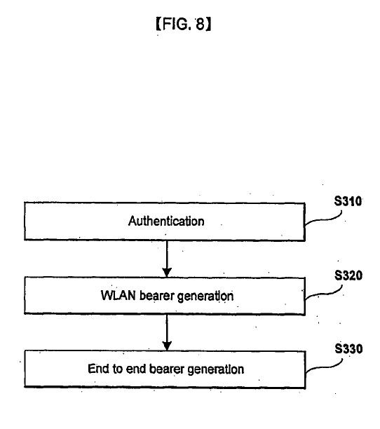

FIG. 8 shows a flowchart representing a QoS negotiation method used when the WLAN UE 10 according to the exemplary embodiment of the present invention performs the WLAN direct IP access.

Firstly, the WLAN UE 10 receives an authentication from the 3GPP AAA server 60 in the 3GPP CN 2 in step S310.

In addition, the WLAN UE 10 negotiates the QoS according to the wireless environment with the WLAN AP 20, and generates the WLAN bearer in step S320. At this time, the WLAN AP 20 negotiates a QoS provided by the Internet or intranet 4 with the terminal equipment 70, and generates the external bearer.

The WLAN UE 10 negotiates a QoS according to the data process performance with the terminal equipment 70, and generates the end-to-end bearer in step S330.

While the exemplary embodiment of the present invention has been described in relation to the 3GPP-WLAN interworking system, it may be realized in a network interworking system including a wireless access network including a wireless access equipment to which a user terminal is accessed, a packet-switched service network including an terminal equipment providing a packet-switched service, a core network connecting the wireless access network and the packet-switched service network, and a gateway relaying the core network and the packet-switched service network.

The above described methods and apparatuses are not only realized by the exemplary embodiment of the present invention, but, on the contrary, are intended to be realized by a program for realizing functions corresponding to the configuration of the exemplary embodiment of the present invention or a recoding medium recoding the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, the WLAN user equipment may exchange the user data with the terminal equipment of the 3GPP packet-switched service network by efficiently negotiating the QoS in the 3GPP WLAN interworking system.

In addition, according to the exemplary embodiment of the present invention, since the security of the WLAN access network which is a different type of network from the 3GPP packet-switched service network is guaranteed, the WLAN user equipment may exchange the user data with the terminal equipment while guaranteeing security of the data when the 3GPP-WLAN interworking system is wirelessly accessed to the WLAN access network.

1. A network interworking system comprising a wireless access network comprising wireless access equipment to which a user terminal is accessed, a packet-switched service network comprising terminal equipment providing a packet-switched service, a core network for connecting the wireless access network and the packet-switched service network, and a gateway relaying the core network and the packet-switched service network, the network interworking system comprising:
a first bearer formed between the user terminal and the wireless access equipment according to a quality of service (QoS) provided according to a wireless environment;
a second bearer formed between the user terminal and the gateway according to a QoS provided according to a type of the user data;
a third bearer formed between the gateway and the terminal equipment according to a QoS provided by the packet-switched service network; and
a fourth bearer formed between the user terminal and the terminal equipment according to a QoS provided according to data process performance.

2. A network interworking system comprising a wireless access network to which a user terminal is accessed, a packet-switched service network providing a packet-switched service, and a core network connecting the wireless access network and the packet-switched service network, the network interworking system comprising:
wireless access equipment being included in the wireless access network and negotiating a first QoS with the user terminal in relation to radio resources provided to the user terminal;
a gateway relaying the core network and the packet-switched service network; and
terminal equipment being included in the packet-switched service network and negotiating a second QoS according to data process performance with the user terminal,
wherein the gateway negotiates a third QoS provided by the packet-switched service network with the terminal equipment, and negotiates a fourth QoS provided according to a type of user data with the user terminal.

3. The network interworking system of claim 2, further comprising a charging server for performing a charging operation according to the fourth QoS provided to the user terminal.

4. A quality of service (QoS) negotiation method of a user terminal, the QoS negotiation method for negotiating a QoS in a network interworking system comprising a wireless access network comprising wireless access equipment to which a user terminal is accessed, a packet-switched service network comprising terminal equipment providing a packet switched service, a core network connecting the wireless access network and the packet-switched service network, and a gateway relaying the core network and the packet-switched service network, the QOS negotiation method comprising:
generating a first bearer negotiating a QoS with the wireless access equipment in the wireless access network, the QoS provided according to a wireless environment;
generating a second bearer negotiating a QoS with the gateway, the QoS provided according to a type of user data; and
generating a third bearer negotiating a QoS with the terminal equipment, the QoS provided according to data process performance of the terminal equipment,
wherein the gateway negotiates a QoS provided by the packet-switched service network with the terminal equipment.

5. A quality of service (QoS) negotiation method of a gateway relaying a core network and a packet-switched service network in a network interworking system comprising a wireless access network to which a user terminal is accessed, the packet-switched service network comprising terminal equipment providing a packet-switched service, and the core network connecting the wireless access network and the packet-switched service network, the QoS negotiation method comprising:
generating a first bearer negotiating a QoS with the user terminal, the QoS provided according to a type of user data; and
generating a second bearer negotiating a QoS with the terminal equipment, the QoS provided by the packet-switched service network,
wherein the user terminal generates a third bearer negotiating a QoS provided according to a wireless environment with the wireless access equipment in the wireless access network, and generates a fourth bearer negotiating a QOS provided according to data process performance of the terminal equipment with the terminal equipment.

6. A quality of service (QoS) negotiation method of a user terminal, the QoS negotiation method for negotiating a QoS in a network interworking system comprising a wireless access network to which the user terminal is wirelessly accessed, the wireless access network connected to a first packet-switched service network providing a packet-switched service, a second packet-switched service network providing the packet-switched service, and a core network connecting the wireless access network and the second packet-switched service network, the QoS negotiation method comprising:
obtaining an authentication from the core network;
generating a first bearer negotiating a QoS according to a wireless environment with a wireless access equipment in the wireless access network; and
generating a second bearer negotiating a QoS according to data process performance with the terminal equipment in the packet-switched service network,
wherein the wireless access equipment generates a third bearer negotiating a QoS negotiated by the first packet-switched service network with the terminal equipment.
